(19) United States
(12) Patent Application Publication
(10) Pub. No.: US 2010/0057984 A1
(43) Pub. Date: Mar. 4, 2010

(54) MEMORY HIERARCHY CONTAINING ONLY NON-VOLATILE CACHE

(75) Inventors: Yiran Chen, Eden Prairie, MN (US); Hai Li, Eden Prairie, MN (US); Hongyue Liu, Maple Grove, MN (US); Haiwen Xi, Prior Lake, MN (US); Song S. Xue, Edina, MN (US)

Correspondence Address: CAMPBELL NELSON WHIPPS, LLC, HISTORIC HAMM BUILDING, 408 SAINT PETER STREET, SUITE 240, ST. PAUL, MN, 55102, US

(73) Assignee: SEAGATE TECHNOLOGY LLC, Scotts Valley, CA (US)

(21) Appl. No.: 12/198,513

(22) Filed: Aug. 26, 2008

(51) Int. Cl. G06F 12/08; G06F 12/00

(52) U.S. Cl. 711/113; 711/103; 711/118; 711/104; 711/E12.001; 711/E12.023

(57) ABSTRACT

A storage system that includes non-volatile main memory; non-volatile read cache; non-volatile write cache; and a data path operably coupled between the non-volatile write cache and the non-volatile read cache, wherein the storage system does not include any volatile cache and methods for retrieving and writing data throughout this memory hierarchy system.

### BACKGROUND

Caches are generally used to increase the performance of memory systems that include relatively slow access portions. For example in an exemplary computer system, access of data from the hard disk is slow and the overall access speed of the whole system could be greatly improved if the data could be obtained from a memory source that is more quickly accessed, such as random access memory (RAM). Generally, computer systems utilize a portion of RAM within the system as a cache for temporarily holding the data most recently accessed from the hard disk. In such a case, the next time the data is desired by the host, it may be obtained from the faster cache instead of the slower hard disk.

Different configurations and methods of using cache configurations are constantly being utilized based on different advantages they may provide. As computer systems advance, new and different configurations of main memory and caches become desirable in order to further increase the performance of computer systems.

### BRIEF SUMMARY

A storage system that includes non-volatile main memory; non-volatile read cache; non-volatile write cache; and a data path operably coupled between the non-volatile write cache and the non-volatile read cache, wherein the storage system does not include any volatile cache.

A storage system that includes non-volatile main memory; cache memory array, wherein the cache memory array includes a read cache; a write cache; and a data path operably coupled between the read cache and the write cache, and wherein the cache memory array includes only non-volatile memory.

A method of managing data in a memory system, wherein the memory system includes non-volatile main memory, non-volatile read cache, non-volatile write cache and data paths operably coupled between the components, wherein the memory system does not include any volatile cache, the method including receiving a command from a host regarding retrieval of data; accessing the non-volatile write cache and determining if the data is contained therein; accessing the non-volatile read cache if the data was not found in the non-volatile write cache; accessing the non-volatile main memory if the data was not found in the non-volatile read cache or the non-volatile write cache; and returning the data to the host.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic illustration of a memory system as disclosed herein;

FIGS. 2a and 2b are schematic illustrations of a memory system as disclosed herein;

FIG. 3 is a flowchart illustrating an exemplary embodiment of a method as disclosed herein;

FIGS. 4a and 4b are schematic illustrations of memory systems as disclosed herein; and

FIG. 5 is a schematic illustration of a memory system as disclosed herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The present disclosure relates to memory hierarchies having only nonvolatile caches as opposed to hierarchies that include volatile cache. In an embodiment, a storage system includes non-volatile main memory and a cache memory array, wherein the cache memory array includes a read cache and a write cache, and therein the cache memory array includes only non-volatile memory; and a data path operably coupled between the read cache and the write cache. In an embodiment, a storage system includes non-volatile main memory, non-volatile read cache, and non-volatile write cache, wherein the storage system does not include any volatile cache.

Storage systems that are disclosed herein can offer desirable characteristics because only non-volatile memory is utilized. One such desirable characteristic relates to unexpected system power offs. When the disclosed storage system unexpectedly powers off, no data will be lost because all of the data is contained in non-volatile memory. All of the data can be recovered and synchronized along the non-volatile write cache, the non-volatile read cache, and the non-volatile main memory. This is different than other memory systems or memory hierarchies that include data (data that may only be stored in a cache) that is in volatile memory. Another such desirable characteristic relates to routine power downs. Because the latest accessed data is stored in non-volatile memory, the data contained therein can be used for an “instant on” operation. Storage systems as disclosed herein can also offer a potential advantage that the size of the non-volatile write cache can be larger than commonly utilized dynamic RAM (DRAM) caches and still consume relatively smaller amounts of power because of the elimination of the need for refreshing.

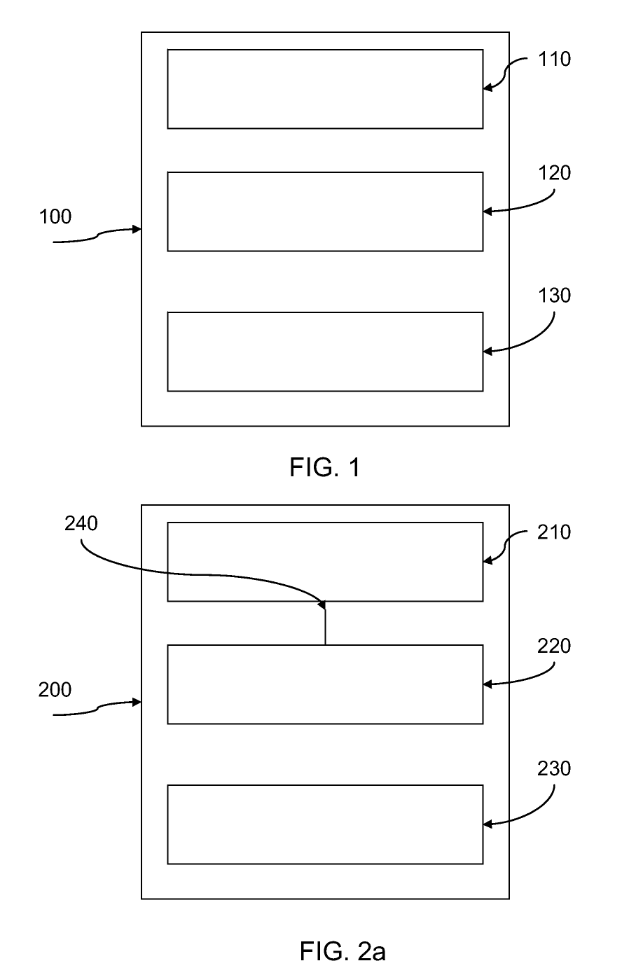

FIG. 1 depicts an exemplary embodiment as disclosed herein. The storage system 100 includes non-volatile main memory 130, non-volatile read cache 120, and non-volatile write cache 110. The exemplary embodiment of FIG. 1 illustrates all three of these components contained together, for example, embedded on one chip. One of skill in the art will also understand, having read this specification, that three components could also be contained at different locations, for example on more than one chip. One of skill in the art will also understand, having read this specification that the different components could be located in disparate locations and still be utilized in a memory hierarchy.

A storage system as described herein includes only non-volatile main memory 130. Non-volatile memory includes any kind of computer memory that can retain information stored thereon when not powered. Any known types of non-volatile memory may be used as the non-volatile main memory. Examples of non-volatile memory that may be utilized as the non-volatile main memory include, but are not limited to, read only memory (ROM), flash memory, hard drives, and random access memory (RAM). Examples of ROM include, but are not limited to, programmable ROM (PROM) which can also be referred to as field programmable ROM; electrically erasable programmable ROM (EEPROM) which is also referred to as electrically alterable ROM (EAROM); and erasable programmable ROM (EPROM). Examples of RAM include, but are not limited to, ferroelectric RAM (FeRAM or FRAM); magnetoresistive RAM (MRAM); resistive RAM (RRAM); non-volatile static RAM (nvSRAM); battery backed static RAM (BBSRAM); phase change memory (PCM) which is also referred to as PRAM, PCRAM and C-RAM; programmable metallization cell (PMC) which is also referred to as conductive-bridging RAM or CBRAM; nano-RAM (NRAM), spin torque transfer RAM (STTRAM) which is also referred to as STRAM; and Silicon-Oxide-Nitride-Oxide-Silicon (SONOS), which is similar to flash RAM. Solid-state drives, which are similar in functioning to hard drives an also be utilized as the non-volatile main memory.

In an embodiment, the non-volatile main memory is a hard disk drive or a solid state drive. In an embodiment, the nonvolatile main memory can also be tape, a memory array of PCM, RRAM, STTRAM, MRAM; or any other large capacity memory array composed of nonvolatile memory cells.

The size, performance and configuration of the non-volatile main memory is not limited. In general, the non-volatile main memory can be sized and configured as is generally known and utilized by those of skill in the art.

A storage system as disclosed herein also includes non-volatile read cache 120. A read cache functions to increase the speed of accessing or reading data from the main memory. The read cache generally includes memory space that corresponds to space within the main memory. The read cache has historically been utilized to alleviate the spin-up and seek time of a disk drive once initiated with power, or the relatively slow access time of a solid state drive due to the large capacity. The amount of data replicated in the read cache will depend on the performance desired, the environmental conditions and the desired cost of the entire system.

A read cache generally functions as follows. When a read command is received from the host to retrieve a data block, the read cache will be examined first. The read cache is searched, comparing the address for the read command to all tags in the read cache. If the tag is found in the read cache, a read cache “hit” has occurred. The data block for the tag is then immediately read and returned to the host. If the address is not found in the read cache, a read cache “miss” has occurred. If a read cache miss occurs, the tag is then sought in the main memory and once found, the data is immediately read and returned to the host. While this is happening the cache also stores the data that was just read from the main memory into the read cache so that it will be there the next time this data is desired.

Any known type of non-volatile memory can be utilized for the non-volatile read cache. Examples of non-volatile memory that may be utilized as the non-volatile read cache include, but are not limited to, ROM, flash memory, hard drives, and RAM. Examples of ROM include, but are not limited to, PROM which can also be referred to as field programmable ROM; EEPROM which is also referred to as EAROM; and EPROM. Examples of RAM include, but are not limited to, FeRAM or FRAM; MRAM; RRAM; nvSRAM; BSRAM; PCM which is also referred to as PRAM, PCRAM and C-RAM; PMC which is also referred to as conductive-bridging RAM or CBRAM; NRAM, STTRAM which is also referred to as STRAM; and SONOS, which is similar to flash RAM.

In an embodiment, the non-volatile read cache is a cache that could be considered a “fast read cache”. A “fast read cache” as used herein generally refers to a cache that can be accessed within about 10 nanoseconds. In an embodiment, a “fast read cache” can refer to a cache that can be accessed within about 10 microseconds. In an embodiment, a “fast read cache” can refer to a cache that can be accessed within about 10 milliseconds.

In an embodiment, the read cache is a cache that could be considered a “slow write cache”. A “slow write cache” as used herein generally refers to a cache that can be programmed (or written to) within about 100 nanoseconds. In an embodiment, a “slow write cache” can refer to a cache that can be written to within about 100 microseconds. In an embodiment, a “slow write cache” can refer to a cache that can be written to within about 100 milliseconds. In an embodiment, the non-volatile read cache is a cache that could be considered both a “fast read cache” and a “slow write cache”, which can also be referred to as a “slow-write, fast-read cache”.

In an embodiment, the non-volatile read cache is a cache that is generally considered large. A “large” cache as used herein generally refers to a cache that has a capacity of about 4 Mbyte or greater. In an embodiment, a large cache has a capacity of about 4 Mbyte to about 1 Gbyte. In an embodiment, a large cache has a capacity of about 1 Gbyte to about 32 Gbyte.

A storage system as disclosed herein also includes non-volatile write cache 110. A write cache functions to increase the speed of writing data to the main memory. In standard memory architecture, not including that disclosed herein data must still be written to system memory every time a write occurs, while also being written into cache. This is necessary in standard memory systems because of the concern of losing updated data files in case of power loss. If the write data is only stored in the cache memory (volatile in normal systems) a loss of power will result in the new updated files being lost from the cache before having the old data updated in the main memory. Utilizing a memory architecture as described herein does not require the redundant write because all of the caches, specifically the write cache, are non-volatile memory.

When a write command is received from the host, it looks first to the write cache. The cache controller reads the address of the data in the cache and compares it to the address given. If they are identical, then the controller knows that the entry in the cache at that line address is the one the host wanted. This is a cache “hit”. If the address of the data doesn't match, then this is a cache miss. For a write cache hit, the cache controller writes the data at the same cache line location referenced by its address. Then, if a write-through cache is being used, the write to memory proceeds; if a write-back cache is being used, the write to memory is canceled, and the dirty bit for this cache line is set to 1 to indicate that the cache was updated but the memory was not. If it is a cache miss, the cache generally doesn't update the cache line on a write miss. The entry that was there is generally left and the data is written to the main memory, bypassing the cache entirely. Some types of caches put all writes into the appropriate cache line whenever a write is done. These types of caches make the assumption that anything the host has just written, it is likely to read back again at some point in the near future. Therefore, they treat every write as a hit, by definition. This means there is no check for a hit on a write; in essence, the cache line that is used by the address just written is always replaced by the data that was just put out by the host. It also means that on a write miss the cache controller must update the cache, including checking the dirty bit on the entry that was there before the write, exactly the same as what happens for a read miss.

Any known type of non-volatile memory can be utilized for the non-volatile write cache. Examples of non-volatile memory that may be utilized as the non-volatile write cache include, but are not limited to, ROM, flash memory, hard drives, and RAM. Examples of ROM include, but are not limited to, PROM which can also be referred to as field programmable ROM; EEPROM which is also referred to as EAROM; and EPROM. Examples of RAM include, but are not limited to, FeRAM or FRAM; MRAM; RRAM; nvSRAM; BSRAM; PCM which is also referred to as PRAM, PCRAM and C-RAM; PMC which is also referred to as conductive-bridging RAM or CBRAM; NRAM, STTRAM which is also referred to as STRAM; and SONOS, which is similar to flash RAM.

In an embodiment, the non-volatile write cache is a cache that could be considered a “fast read cache” as is discussed above. In an embodiment, the write cache is a cache that could be considered a “fast write cache”. A “fast write cache” as used herein generally refers to a cache that can be written to within about 10 nanoseconds. In another embodiment, a “fast write cache” is a cache that can be written to within about 10 microseconds. In another embodiment, a “fast write cache” is a cache that can be written to within about 10 milliseconds. In an embodiment, the non-volatile write cache is a cache that could be considered both a “fast read cache” and a “fast write cache”, which can also be referred to as a “fast write, fast read cache”.

In an embodiment, the non-volatile write cache is a cache that is generally considered small. A “small” cache as used herein generally refers to a cache that has a capacity of about 512 Kbytes or less. In an embodiment, a small cache has a capacity of about 512 Kbytes to about 4 Mbytes. In an embodiment, a small cache has a capacity of about 4 Mbytes to about 32 Mbytes.

In an embodiment, the non-volatile write cache and the non-volatile read cache are contained in the same kind of non-volatile memory. In an embodiment, the non-volatile write cache and the non-volatile read cache are contained in different kinds of memory. In an embodiment, the non-volatile read cache is contained in PROM (which can also be referred to as field programmable ROM), EEPROM (which can also referred to as EAROM), EPROM, MRAM, nvSRAM, BSRAM, PCM (which is also referred to as PRAM, PCRAM and C-RAM), NRAM, and SONOS, which is similar to flash RAM. In an embodiment, the non-volatile write cache is contained in STTRAM, PMC, FeRAM (or FRAM) or RRAM. In an embodiment, the non-volatile read cache is contained in PROM (which can also be referred to as field programmable ROM), EEPROM (which can also referred to as EAROM), EPROM, MRAM, nvSRAM, BSRAM, PCM (which is also referred to as PRAM, PCRAM and C-RAM), NRAM, and SONOS, which is similar to flash RAM; and the non-volatile write cache is contained in STTRAM, PMC, FeRAM (or FRAM) or RRAM. Such an exemplary embodiment can offer advantages because the slow speed and low cost of the non-volatile memory types can offer advantageous characteristics for a slow, large non-volatile read cache; and the high speed with associated high cost of the non-volatile memory types can offer advantageous characteristics for a fast, small non-volatile write cache. The advantages provided by such an embodiment are realized because read cache is generally capacity driven while write cache is generally speed driven.

In an embodiment, the non-volatile read cache is contained in PROM (which can also be referred to as field programmable ROM), EEPROM (which can also referred to as EAROM), EPROM, MRAM, nvSRAM, BSRAM, PCM (which is also referred to as PRAM, PCRAM and C-RAM), NRAM, and SONOS, which is similar to flash RAM; and the non-volatile write cache is contained in STTRAM. In an embodiment, the non-volatile read cache is contained in PROM (which can also be referred to as field programmable ROM), EEPROM (which can also referred to as EAROM), EPROM, MRAM, nvSRAM, BSRAM, PCM (which is also referred to as PRAM, PCRAM and C-RAM), NRAM, and SONOS, which is similar to flash RAM; and the non-volatile write cache is contained in PMC. In an embodiment, the non-volatile read cache is contained in PROM (which can also be referred to as field programmable ROM), EEPROM (which can also referred to as EAROM), EPROM, MRAM, nvSRAM, BSRAM, PCM (which is also referred to as PRAM, PCRAM and C-RAM), NRAM, and SONOS, which is similar to flash RAM; and the non-volatile write cache is contained in FeRAM (or FRAM). In an embodiment, the non-volatile read cache is contained in PROM (which can also be referred to as field programmable ROM), EEPROM (which can also referred to as EAROM), EPROM, MRAM, nvSRAM, BSRAM, PCM (which is also referred to as PRAM, PCRAM and C-RAM), NRAM, and SONOS, which is similar to flash RAM; and the non-volatile write cache is contained in RRAM.

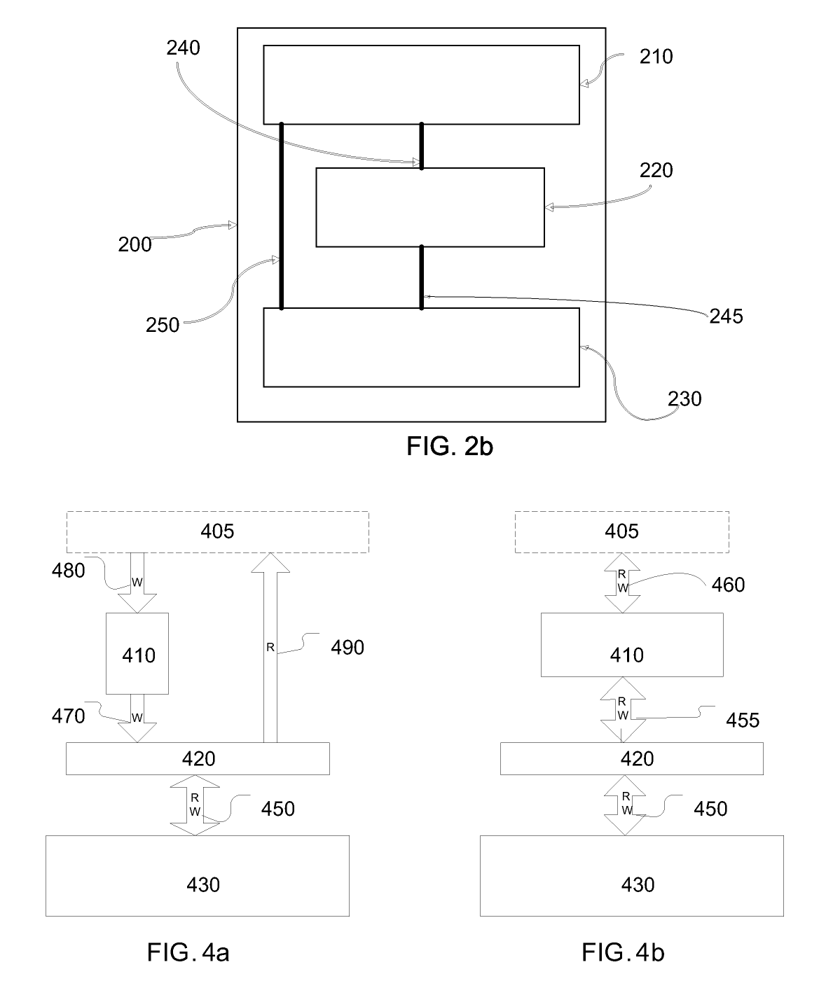

In an embodiment, a storage system includes non-volatile main memory; non-volatile read cache; non-volatile write cache; and a data path operably coupled between the non-volatile write cache and the non-volatile read cache, wherein the storage system does not include any volatile cache. FIG. 2a depicts such an exemplary embodiment of a storage system. The storage system 200 includes non-volatile main memory 230, non-volatile read cache 220 and non-volatile write cache 210. The embodiment depicted in FIG. 2a also includes a data path 240. Data paths generally function to transfer data between components (in only one direction or in both directions), and are therefore operably coupled between the components. The data path 240 depicted in FIG. 2a operably couples the non-volatile read cache 220 and the non-volatile write cache 210. FIG. 2b depicts another exemplary embodiment that includes more than one data path. This embodiment includes a first data path 240 that operably couples the non-volatile read cache 220 to the non-volatile write cache 210; a second data path 245 that operably couples the non-volatile read cache 220 to the non-volatile main memory 230; and a third data path 250 that operably couples the non-volatile write cache 210 to the non-volatile main memory 230.

Data paths as are generally known to those of skill in the art can be utilized herein. One example includes a bus that is similar to a memory bus between a personal computer (PC) memory and the cache of the PC hard drive.

Systems as described herein can also generally include other components as would be known to one of skill in the art. Examples of such other exemplary components include, but are not limited to, controllers, input output (I/O) interfaces, other types of communication channels, and motherboards for example. One of skill in the art, having read this specification, would know how and why such optional components can be utilized and how to incorporate them into a system as disclosed herein.

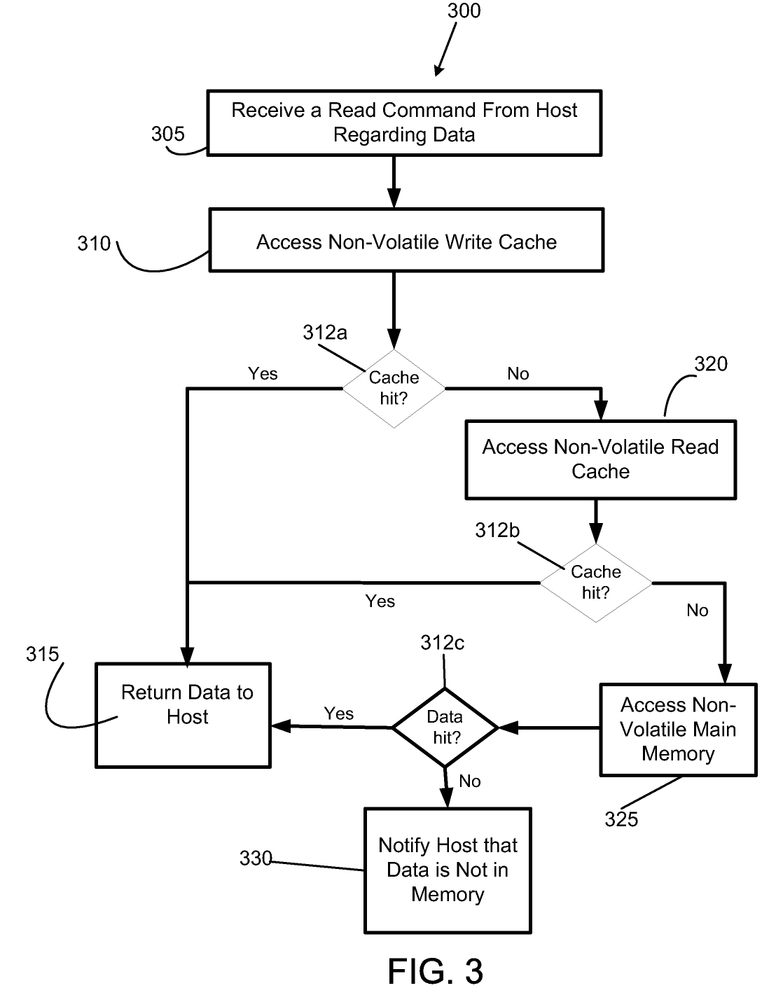

Also disclosed herein are methods of managing data in memory systems as disclosed herein. FIG. 3 depicts an exemplary embodiment of such a method, in which a non-volatile write cache functions as a filter cache during a read command. As seen in FIG. 3, the first step in an exemplary method 300 of managing data in a memory system, depicted as 305 is to receive a write command from a host regarding data. The term host as used herein refers to a processor or a system interface of a system that can issue read and/or write commands to memory storage in the system. The system may be a general purpose computer system such as a PC (e.g., a notebook computer; a desktop computer), a server, or it may be a dedicated machine. The command generally can be a read command or a write command. Generally, a read command is a command that requests data from a memory system; and a write command is a command that requests that data be written to a memory system. One of skill in the art would know, having read this specification, how to configure a memory system in order to receive and respond to commands (regarding reading and writing) from a host. In this particular exemplary method, the command from the host is a read command.

The next step in an exemplary method of managing data in a memory system is illustrated by 310, the step includes accessing the non-volatile write cache. This step can access the non-volatile write cache to determine if the data that is the subject of the command received in step 305 is included in the non-volatile write cache. Generally utilized structures and protocols for accessing and interrogating the non-volatile write cache can be utilized, as would be known by one of skill in the art having read this specification.

Once the non-volatile write cache has been accessed, a determination is made as to whether or not the data (that is the subject of the command from the host) is contained in the non-volatile write cache, this determination is depicted as 312a in FIG. 3. If the data is contained in the non-volatile write cache, the data is then returned to the host, as depicted at step 315. Generally utilized structures and protocols for returning data from the non-volatile write cache to the host can be utilized, as would be known by one of skill in the art having read this specification. If the data is not contained in the non-volatile write cache, the next step is to access the non-volatile read cache, to determine if the data that is the subject of the command received in step 305 is included in the non-volatile read cache, this step is depicted as step 320 in FIG. 3. Generally utilized structures and protocols for accessing and interrogating the non-volatile read cache can be utilized, as would be known by one of skill in the art having read this specification.

Once the non-volatile read cache has been accessed, a determination is made as to whether or not the data (that is the subject of the command from the host) is contained in the non-volatile read cache, this determination is depicted as 312b in FIG. 3. If the data is contained in the non-volatile read cache, the data is then returned to the host, as depicted at step 315. Generally utilized structures and protocols for returning data from the non-volatile read cache to the host can be utilized, as would be known by one of skill in the art having read this specification. If the data is not contained in the non-volatile read cache, the next step is to access the non-volatile main memory, to determine if the data that is the subject of the command received in step 305 is included in the non-volatile main memory, this step is depicted as step 325 in FIG. 3. Generally utilized structures and protocols for accessing and interrogating the non-volatile main memory can be utilized, as would be known by one of skill in the art having read this specification.

Once the non-volatile read main memory has been accessed, a determination is made as to whether or not the data (that is the subject of the command from the host) is contained in the non-volatile main memory, this determination is depicted as 312c in FIG. 3. If the data is contained in the non-volatile main memory, the data is then returned to the host, as depicted at step 315. Generally utilized structures and protocols for returning data from the non-volatile main memory to the host can be utilized, as would be known by one of skill in the art having read this specification. If the data is not contained in the non-volatile main memory, the next step is to notify the host that the data is not in the memory, this step is depicted as step 330, in FIG. 3. Generally utilized structures and protocols for notifying the host can be utilized, as would be known by one of skill in the art having read this specification.

The exemplary method depicted in FIG. 3 can offer advantages over methods not utilizing the memory system disclosed herein and/or this exemplary method. For example, the non-volatile write cache functions as another level of memory hierarchy between the non-volatile read cache and the host. This can reduce the frequency at which the non-volatile read cache is accessed. In embodiments where the non-volatile write cache is a small size, fast-write fast-read cache, and the non-volatile read cache is a large size, slow-write fast-read cache, such a system can decrease access time for data but still maintain an efficient and affordable memory system.

In the exemplary method depicted in FIG. 3 write through policy can be applied to ensure that the data in the non-volatile write cache and the non-volatile read cache are synchronized. Generally utilized structures and protocols for carrying out write through policy can be utilized, as would be known by one of skill in the art having read this specification. When utilizing an exemplary method such as that depicted in FIG. 3, for processing read commands from a host, write commands can be processed by writing data into the non-volatile write cache first for all commands, setting corresponding entries in the non-volatile read cache to “invalid”, and updating the entries in the read cache at a later time. Generally utilized structures and protocols for carrying out such steps can be utilized, as would be known by one of skill in the art having read this specification. In some embodiments this can also afford advantages because of the time advantage of writing to a fast-write fast-read cache (i.e. the non-volatile write cache) when under time constraints and then writing to the slow-write fast-read cache (i.e. the non-volatile read cache) at a later time when system resources aren't currently being utilized.

In the embodiment depicted in FIG. 3, a pre-fetch protocol can be, but need not be, utilized when data is being loaded from the non-volatile read cache to the non-volatile write cache. Generally utilized structures and protocols for pre-fetch protocols can be utilized, as would be known by one of skill in the art having read this specification.

Also disclosed herein is an exemplary method of utilizing a memory system, wherein the memory system includes non-volatile main memory, non-volatile read cache, and non-volatile write cache, wherein the storage system does not include any volatile cache; the method includes receiving a command from a host regarding retrieval of data; accessing the non-volatile write cache and determining if the data is contained therein; accessing the non-volatile read cache if the data was not found in the non-volatile write cache; accessing the non-volatile main memory if the data was not found in the non-volatile read cache or the non-volatile write cache; and returning the data to the host if it was found.

FIGS. 4a and 4b illustrate further exemplary memory systems as described herein. The memory systems in FIGS. 4a and 4b can be utilized if the access latency of the writing cache, i.e. the non-volatile write cache, is the rate limiting step of the system. The embodiment in FIG. 4a generally provides a system where the non-volatile write cache functions as a store queue for writing. The exemplary embodiment includes non-volatile main memory 430, non-volatile read cache 420 and non-volatile write cache 410; and as in the other memory systems exemplified herein, there is no volatile cache.

The exemplary embodiment of FIG. 4a is an example of a memory system where the non-volatile write cache provides the function of a store queue, or a writing buffer. In utilizing the embodiment depicted in FIG. 4a, commands from a host (depicted as host 405) to write data can write the data into the non-volatile write cache 410 before it is written into the non-volatile read cache 420. The path of a write command from the host 405 to the non-volatile main memory 430 can be illustrated by the path from the host 405 via the first arrow 480 to the non-volatile write cache 410 via the second arrow 470 to the non-volatile read cache 420 via the third arrow 450 to the non-volatile main memory 430.

Such a configuration, when given a command to write data into the non-volatile main memory (generally the slowest write time), can write the data into the non-volatile write cache (generally the fastest write time) and wait until the data paths between the non-volatile read cache (represented by arrow 470) and the non-volatile main memory (represented by arrow 450) are free.

Commands from a host 405 to read data utilizing an embodiment of FIG. 4a are generally handled directly by the non-volatile read cache 420 which is depicted by the fourth arrow 490 or non-volatile main memory 430 (depending on where the data is ultimately found) depicted by the bidirectional arrow 450.

The embodiment in FIG. 4b generally provides a system where the non-volatile write cache functions as both a load queue and a store queue for reading and writing. The exemplary embodiment includes non-volatile main memory 430, non-volatile read cache 420 and non-volatile write cache 410; and as in the other memory systems exemplified herein, there is no volatile cache. In utilizing the embodiment depicted in FIG. 4b, commands from a host (depicted as host 405) to write data can write the data into the non-volatile write cache 410 before it is written into the non-volatile read cache 420. The path of a write command from the host 405 to the non-volatile memory can be illustrated by the path shown from the host 405 via the first arrow 460, to the non-volatile write cache 410, via the second arrow 455, to the non-volatile read cache 420, via the third arrow 450 to the non-volatile main memory 430. Such a configuration, when given a command to write data into the non-volatile main memory (generally the slowest write time), can write the data into the non-volatile write cache (generally the fastest write time) and wait until the data paths between the non-volatile read cache (represented by arrow 455) and the non-volatile main memory (represented by arrow 450) are free.

Commands from a host 405 to read data utilizing an embodiment of FIG. 4b can generally be read from the non-volatile write cache 410 before the non-volatile read cache 420 or the non-volatile main memory 430. The path of a read command from the host 405 to the non-volatile memory can be illustrated by the path shown by the first arrow 460, through the non-volatile write cache 410, the second arrow 455, the non-volatile read cache 420, the third arrow 450 and then finally to the non-volatile main memory 430. Through this configuration, the non-volatile write cache 410 can function as a buffer. Specifically, the first portion of the buffer can be read from the non-volatile read cache directly and after that, the rest of the data can be pre-fetched into the non-volatile write cache 410 and returned to the host 405 when all data paths are free.

Generally utilized structures and protocols for forming and utilizing data paths represented in FIGS. 4a and 4b can be utilized, as would be known by one of skill in the art having read this specification. The queue function of the non-volatile write cache 410 depicted in FIGS. 4a and 4b can be implemented as a first in first out (FIFO) queue, a stack, a content accessible memory (CAM), other queue implementations known to one of skill in the art, or some combination thereof. Generally utilized structures and protocols for forming and utilizing the queue and its specific implementation can be utilized, as would be known by one of skill in the art having read this specification.

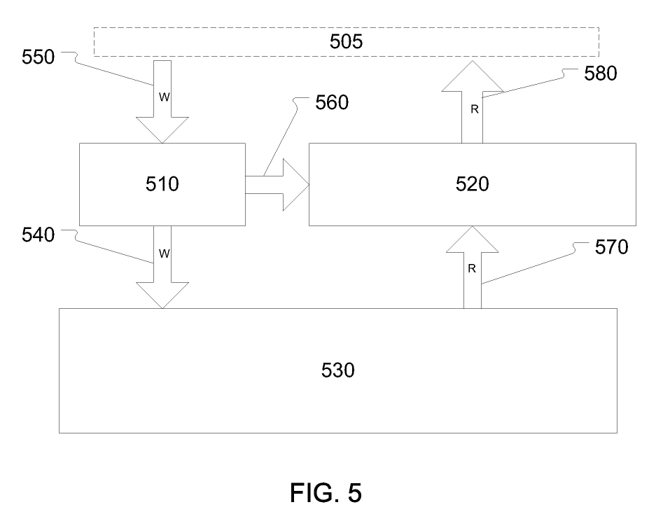

FIG. 5 illustrates a further exemplary memory system as described herein. The embodiment in FIG. 5 generally provides a system where the non-volatile write cache and the non-volatile read cache function in parallel. It could also be stated that such a system functions so that data is always written into the non-volatile write cache and can be read from non-volatile read cache or non-volatile main memory (if not contained in the non-volatile read cache). The exemplary embodiment includes non-volatile main memory 530, non-volatile read cache 520 and non-volatile write cache 510; and as in the other memory systems exemplified herein, there is no volatile cache. The non-volatile read cache 520 and the non-volatile write cache 510 function in parallel. When a command to write to the memory is received from the host (depicted as 505), the data is always written into the non-volatile write cache 510, this action is depicted by the w arrow 550. When a command to read from the memory is received from the host 505, the data is first sought in the non-volatile read cache 520, the path designated as the r arrow 580; and if not located therein it is then sought in the non-volatile main memory 530, the path designated as the r arrow 570.

This exemplary embodiment also includes a direct access channel or a data path operably coupled between the non-volatile write cache 510 and the non-volatile read cache 520, which is designated by the arrow 560. In such a case, a write through policy is applied between the non-volatile write cache and both the non-volatile read cache and the non-volatile main memory. Write through policy in this context implies that data in lower memory hierarchies (e.g. non-volatile read cache and/or non-volatile main memory) are always updated when data is being written into the current memory level (e.g. non-volatile write cache). Very often, access of information in memory (e.g. hard drive access) occurs in a burst fashion, this exemplary embodiment allows the data in the non-volatile read cache and the non-volatile write cache to be updated where there a burst of memory access is not occurring, i.e. where the data channel is otherwise free. This timely synchronization occurs via the data path that is operably coupled between the non-volatile read cache and the non-volatile write cache, which can also be referred to as a direct cache channel (DCC). A DCC that can function in this context can provide an advantage that when power is off to the non-volatile main memory (e.g. the hard drive or the solid state drive for example), the non-volatile read cache and the non-volatile write cache can function as the hard drive, or SSD, or lowest level memory hierarchy.

Memory systems such as those disclosed herein, and methods of using such memory systems as were described herein can be advantageously utilized in many different computer systems. Particular advantages can be obtained in writing intensive applications, i.e. those with random access behavior. Exemplary types of these applications include, but are not limited to, transaction process systems (banks, E-commerce, etc.), Hi-cap mode of scientific computing (caching large amounts of various data structures in a hard drive), and P2P downloading.

Thus, embodiments of memory hierarchies containing only non-volatile cache are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A storage system comprising:
non-volatile main memory;
non-volatile read cache;
non-volatile write cache; and
a data path operably coupled between the non-volatile write cache and the non-volatile read cache,
wherein the storage system does not include any volatile memory.

2. The storage system according to claim 1, wherein the non-volatile main memory is a hard drive.

3. The storage system according to claim 1, wherein the non-volatile main memory is a solid state drive.

4. The storage system according to claim 1, wherein the non-volatile write cache has a small size and fast read and write operation.

5. The storage system according to claim 1, wherein the non-volatile read cache has a large size, fast read and slow write operation

6. The storage system according to claim 1, wherein the non-volatile write cache is STTRAM, FeRAM, RRAM or PMC.

7. The storage system according to claim 6, wherein the non-volatile read cache is PROM, EEPROM, EPROM, MRAM, nvSRAM, BSRAM, PCM, NRAM, or SONOS.

8. A method of managing data in a memory system that does not include any volatile cache comprising:
receiving a command from a host regarding retrieval of data;
accessing a non-volatile write cache and determining if the data is contained therein;
accessing a non-volatile read cache if the data was not found in the non-volatile write cache and determining if the data is contained therein;
accessing a non-volatile main memory if the data was not found in the non-volatile read cache or the non-volatile write cache; and
returning the data to the host.

9. The method according to claim 8 further comprising receiving a command regarding writing data and writing the data to the non-volatile write cache.

10. The method according to claim 9 further comprising setting a corresponding entry in the non-volatile read cache to invalid.

11. The method according to claim 9 further comprising writing the data into the non-volatile read cache when a data path from the non-volatile write cache to the non-volatile read cache is not busy.

12. The method according to claim 11 further comprising writing the data into the non-volatile main memory when a data path from the non-volatile write cache to the non-volatile main memory is not busy.

13. The method according to claim 8 further comprising directly sending the data found in the non-volatile main memory to the host.

14. The method according to claim 8 further comprising sending the data found in the non-volatile main memory to the host sequentially through the non-volatile read cache and then the non-volatile write cache.

15. The method according to claim 8 further comprising sending the data found in the non-volatile read cache to the host through the non-volatile write cache.

16. The method according to claim 11, wherein the data written into the non-volatile read cache is written based on a first in first out policy, a stack policy, or a content accessible memory policy.

17. A storage system comprising:
non-volatile main memory;
a cache memory array, wherein the cache memory array comprises:
a read cache; and
a write cache, wherein the cache memory array consists only of non-volatile memory; and
a data path operably coupled between the read cache and the write cache.

18. The storage system according to claim 17, wherein the read cache is at least about 4 MB of non-volatile memory; and the write cache is not greater than about 32 MB of non-volatile memory.

19. The storage system according to claim 17, wherein the non-volatile write cache is STTRAM, FeRAM, RRAM or PMC.

20. The storage system according to claim 19, wherein the non-volatile read cache is PROM, EEPROM, EPROM, MRAM, nvSRAM, BSRAM, PCM, NRAM, or SONOS.
